(19) United States
(12) Patent Application Publication
(10) Pub. No.: US 2014/0030016 A1
(43) Pub. Date: Jan. 30, 2014

(54) TELESCOPIC PIPE CONNECTION DEVICE

(71) Applicant: YU CHIEH LEE, TAINAN CITY (TW)

(72) Inventor: YU CHIEH LEE, TAINAN CITY (TW)

(21) Appl. No.: 13/558,710

(22) Filed: Jul. 26, 2012

(51) Int. Cl. F16B 7/10

(52) U.S. Cl. 403/355

(57) ABSTRACT

A telescopic pipe connection device includes a fixing sleeve mounted on an outer pipe; a setting-up case internally defining a slide way and a horizontal through hole, the latter extending through the setting-up case and a front wall of the fixing sleeve to communicate with the slide way; a cap fixed to an open front side of the setting-up case and having a receiving hole; a locating pin located in the horizontal through hole with a first end extended through the outer pipe into a limiting hole on an inner pipe and a second end engaged with the receiving hole, and having at least one coupling lever provided thereon; a return spring fitted on the locating pin with two ends pressed against the coupling lever and the cap; and a pushbutton slidably received in the slide way with a lower front slant working face pressed against the coupling lever.

### FIELD OF THE INVENTION

The present invention relates to a telescopic pipe connection device mounted on an outer pipe and an inner pipe telescopically received in the outer pipe to adjustably connect the outer and inner pipes to each other.

### BACKGROUND OF THE INVENTION

A conventional locking device for telescopic pole of tent frame includes an inner pipe and an outer pipe, both of which have a locating hole formed thereon. A locating seat is fixedly mounted on around the outer pipe, and a pushbutton is pivotally connected at a middle section to the locating seat. The pushbutton has an end provided with a locating pin, and another end pressed against a return spring. The locating pin is aligned with the locating hole on the outer pipe. To deploy the tent frame, first pull the inner pipe from the outer pipe. When the locating pin is also aligned with the locating hole on the inner pipe, the return spring automatically pushes the locating pin into the locating hole on the inner pipe to achieve the purpose of automatic locking of the inner pipe to the outer pipe. While the locking device realizes the purpose of automatic locking a telescopic pipe, it has the following drawbacks: The pivotal connection of the middle section of the pushbutton to the locating seat involves complicated structure and can not be conveniently manufactured; and the pivot point is easily damaged to shorten the service life of the locating device.

### SUMMARY OF THE INVENTION

A primary object of the present invention is to provide an improved telescopic pipe connection device that can be conveniently manufactured and is easily operable to achieve the advantages of automatic locating, long service life and enhanced structural strength, so as to overcome the drawbacks in the prior art, such as complicated structure, difficult to manufacture, and short service life.

To achieve the above and other objects, the telescopic pipe connection device according to an embodiment of the present invention is mounted on an outer pipe and an inner pipe telescopically received in the outer pipe and having a vertical line of spaced limiting holes provided on one side thereof. The telescopic pipe connection device includes a fixing sleeve fitted on around an upper end of the outer pipe; a setting-up case fixedly connected to an outer side of a first wall of the fixing sleeve and internally defining a slide way communicating with an open top thereof, the setting-up case having a fitting surface opposite to and spaced from the first wall and further internally defining a horizontal through hole, which has an outer end located on the fitting surface and extends through the setting-up case and the first wall of the fixing sleeve to communicate with the slide way; a cap removably attached to the fitting surface of the setting-up case and having a receiving hole formed thereon; a locating pin slidably extended through the horizontal through hole, the locating pin having a first end extended through the outer pipe to engage with one of the limiting holes and a second end engaged with the receiving hole, and the locating pin being provided on a peripheral surface with at least one coupling lever; a return elastic element fitted on around the locating pin with two ends pressed against the coupling lever and the cap; and a pushbutton slidably received in the slide way and having slant working faces formed on front edges of a lower portion thereof. Further, the coupling lever is pressed against the slant working faces.

The second end of the locating pin has a non-circular cross-sectional shape and the receiving hole has a cross-sectional shape matching that of the second end of the locating pin.

The locating pin is provided on the peripheral surface with two coupling levers, which are symmetrically arranged relative to a centerline of the locating pin.

According to a feasible embodiment, the horizontal through hole has two radially inward protruded ribs symmetrically formed on an inner wall surface thereof, and the two coupling levers are rest on the two protruded ribs.

According to a feasible embodiment, the pushbutton includes a button head and two laterally spaced working portions fixedly connected to a lower side of the button head; the slant working faces are separately formed on front edges of lower portions of the two working portions; and the locating pin is located between the two working portions.

The front edge of each of the working portions includes a straight section, a slant section downward and rearward extended from the straight section, and a hook section extended from the slant section.

According to another feasible embodiment, the pushbutton includes a button head, a straight portion fixedly connected to a lower side of the button head and having a straight front edge, a work portion fixedly connected to a lower edge of the straight portion and having a slant front edge, and a hook portion extended from the working portion.

To achieve the above and other objects, the telescopic pipe connection device according to another embodiment of the present invention is mounted on an outer pipe and an inner pipe telescopically received in the outer pipe and having a vertical line of spaced limiting holes provided on one side thereof. The telescopic pipe connection device includes a fixing sleeve fitted on around an upper end of the outer pipe; a setting-up case fixedly connected to an outer side of a first wall of the fixing sleeve and internally defining a slide way communicating with an open right side thereof, the setting-up case having a fitting surface opposite to and spaced from the first wall and further internally defining a horizontal through hole, which has an outer end located on the fitting surface and extends through the setting-up case and the first wall of the fixing sleeve to communicate with the slide way; a cap removably attached to the fitting surface of the setting-up case and having a receiving hole formed thereon; a locating pin slidably extended through the horizontal through hole, the locating pin having a first end extended through the outer pipe to engage with one of the limiting holes and a second end engaged with the receiving hole, and the locating pin being provided on a peripheral surface with at least one coupling lever; a return elastic element fitted on around the locating pin with two ends pressed against the coupling lever and the cap; and a pushbutton slidably received in the slide way and having slant working faces formed on front edges of a left portion thereof. Further, the coupling lever is pressed against the slant working faces.

To achieve the above and other objects, the telescopic pipe connection device according to a further embodiment of the present invention is mounted on an outer pipe and an inner pipe telescopically received in the outer pipe and having a vertical line of spaced limiting holes provided on one side thereof. The telescopic pipe connection device includes a fixing sleeve fitted on around an upper end of the outer pipe; a setting-up case fixedly connected to an outer side of a first wall of the fixing sleeve and internally defining a slide way communicating with an open left side thereof, the setting-up case having a fitting surface opposite to and spaced from the first wall and internally defining a horizontal through hole, which has an outer end located on the fitting surface and extends through the setting-up case and the first wall of the fixing sleeve to communicate with the slide way; a cap removably attached to the fitting surface of the setting-up case and having a receiving hole formed thereon; a locating pin slidably extended through the horizontal through hole, the locating pin having a first end extended through the outer pipe to engage with one of the limiting holes and a second end engaged with the receiving hole, and the locating pin being provided on a peripheral surface with at least one coupling lever; a return elastic element fitted on around the locating pin with two ends pressed against the coupling lever and the cap; and a pushbutton slidably received in the slide way and having slant working faces formed on front edges of a right portion thereof. Further, the coupling lever is pressed against the slant working faces.

The present invention is superior to the prior art because it provides the following beneficiary effects:
(1) When the pushbutton is pushed, the coupling levers pressed against the slant working faces along with the locating pin are moved backward and the return elastic element is compressed between the coupling levers and the cap to store elastic energy. When the locating pin is finally slid backward to disengage its first end from the limiting hole on the inner pipe, the inner pipe can be conveniently slid in the outer pipe to a desired position relative to the outer pipe. After the inner pipe has been adjusted in position with a selected limiting hole aligned with the working hole on the outer pipe, the pushbutton is released, and the return elastic element will elastically bias the locating pin forward, so that the first end of the locating pin automatically inserts into the selected limiting hole on the inner pipe to achieve the automatic locating function. With the pushbutton slidably received in the slide way and with the coupling levers pressed against the slant working faces of the pushbutton, the connection device can be conveniently fabricated and operated to provide prolonged service life without becoming damaged easily.
(2) The second end of the locating pin and the receiving hole on the cap have matching non-circular cross-sectional shape, so that the locating pin engaged with the receiving hole is prevented from rotating relative to the setting-up case to ensure constant pressing of the coupling levers on the slant working faces of the pushbutton.
(3) The two coupling levers are symmetrically arranged relative to the centerline of the locating pin, allowing the locating pin to stably move forward or backward in the horizontal through hole.
(4) The two coupling levers can be rest on two protruded ribs in the horizontal through hole, allowing the locating pin to stably move forward or backward in the horizontal through hole.
(5) The locating pin is located between the two working portions of the pushbutton to realize reasonable interior spatial design for the locating pin to stably move forward or backward in the horizontal through hole.
(6) The pushbutton includes straight portions that prevent the first end of the locating pin from being too deeply inserted into the limiting hole, and hook portions that retain the locating pin to a locked state when the first end of the locating pin has been inserted into the limiting hole.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a telescopic pipe connection device according to a first embodiment of the present invention;

FIG. 2 is an assembled perspective view of the telescopic pipe connection device according to the first embodiment of the present invention;

FIG. 3 is an assembled sectional side view of the telescopic pipe connection device according to the first embodiment of the present invention;

FIG. 4 is a perspective view showing a tent frame using the telescopic pipe connection device according to the present invention;

FIG. 5 is an exploded perspective view of a telescopic pipe connection device according to a second embodiment of the present invention;

FIG. 6 is an assembled perspective view of the telescopic pipe connection device according to the second embodiment of the present invention;

FIG. 7 an exploded perspective view of a telescopic pipe connection device according to a third embodiment of the present invention; and

FIG. 8 is an assembled perspective view of the telescopic pipe connection device according to the third embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

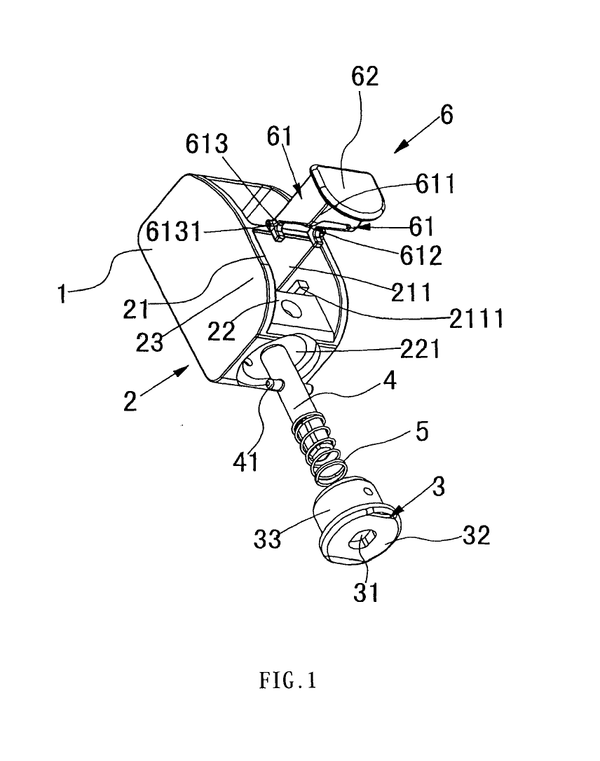

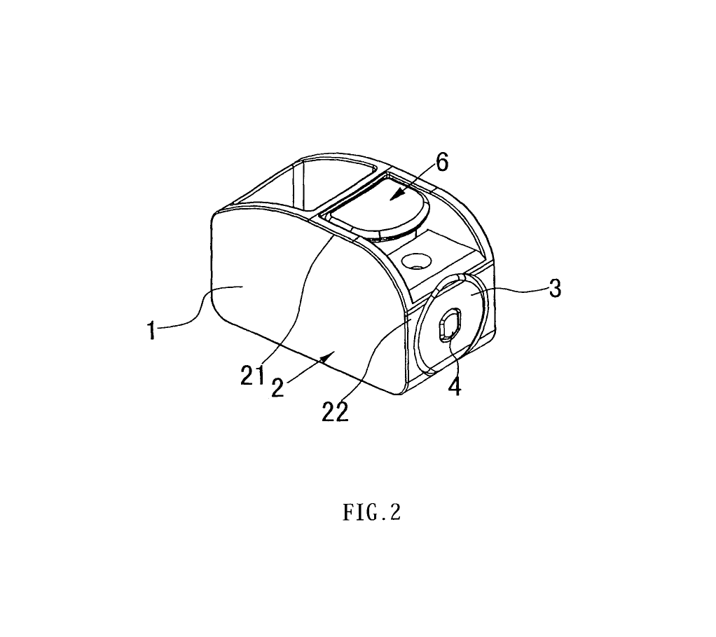

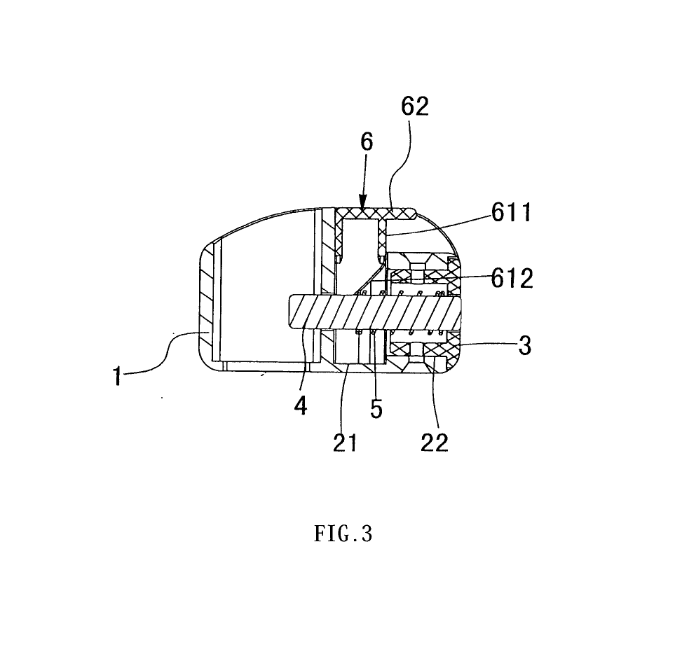

Please refer to FIGS. 1, 2 and 3, in which a telescopic pipe connection device according to a first embodiment of the present invention is shown. The telescopic pipe connection device is mounted on an outer pipe and an inner pipe telescopic ally received in the outer pipe. The outer pipe is provided near an upper end with a working hole, which is a through hole. The inner pipe is provided on one side with a vertical line of spaced limiting holes. The telescopic pipe connection device includes a fixing sleeve 1, a setting-up case 2, a cap 3, a locating pin 4, a return spring 5, and a pushbutton 6.

The fixing sleeve 1 is fitted on around the upper end of the outer pipe and has four walls.

The setting-up case 2 includes a main case 21 and a secondary case 22. The main case 21 is fixedly connected to an outer side of a front wall of the fixing sleeve 1 (i.e. the first wall referred to in the summary of the invention), the secondary case 22 is fixedly connected to an outer side of a front wall of the main case 21 and has an open front side (i.e. the fitting surface referred to in the summary of the invention), and the setting-up case 2 also includes a left and a right wall that upward extend to form two stop plates 23, such that the whole connection device forms an integral body. The main case 21 has an open top and internally defines a slide way 211. The slide way 211 is provided on an inner side of a left and a right wall with a slide rail 2111 each. The secondary case 22 internally defines a horizontal through hole 221 which has an outer end located on the open front side of the secondary case 22 and extends through the setting-up case 2 and the front wall of the fixing sleeve 1 to communicate with the slide way 211 in the main case 21.

The fixing sleeve 1 and the setting-up case 2 are integrally formed with each other.

The cap 3 is removably attached to the open front side of the secondary case 22 to close the outer end of the horizontal through hole 221. The cap 3 has a receiving hole 31 formed thereon, and includes a head portion 32 and a sleeve portion 33 fixedly connected to an inner side of the head portion 32. The sleeve portion 33 is inserted into the horizontal through hole 221 to not only enable enhanced connection strength between the cap 3 and the secondary case 22, but also give the cap increased structural strength.

The locating pin 4 is slidably extended through the horizontal through hole 221, and is provided on a peripheral wall with two coupling levers 41, which are symmetrically arranged relative to a centerline of the locating pin 4. The locating pin 4 has a first end extending through the outer pipe into one of the limiting holes on the inner pipe, and a second end engaged with the receiving hole 31. The second end of the locating pin 4 has a non-circular cross-sectional shape, and the receiving hole 31 has a cross-sectional shape matching that of the second end of the locating pin 4.

The return spring 5 is fitted around the locating pin 4 with two ends separately pressed against the two coupling levers 41 and the cap 3.

The pushbutton 6 is slidably received in the slide way 211. The pushbutton 6 includes a button head 62 and two laterally spaced working portions 61 fixedly connected to a lower side of the button head 62. The locating pin 4 is located between the two working portions 61. Each of the two working portions 61 includes a straight portion 611, which is fixedly connected to one lateral end of the lower side of the button head 62 and has a straight front edge; a slant portion 612, which is fixedly connected to a lower edge of the straight portion 611 and has a slant front edge; and a hook portion 613 extended from the slant portion 612. The slant front edge of the slant portion 612 is rearward and downward inclined. A first limiting protrusion 6131 is protruded from an outer surface of the hook portion 613.

Outer sides of the left and the right working portion 61 are slidably rest on the two slide rails 2111 with relatively small contact areas and frictional force between the working portions 61 and the slide rails 2111. When the pushbutton 6 is downward slid to a predetermined position, left and right ends of the lower side of the button head 62 will become rest on upper ends of the two slide rails 2111 and thereby define a maximum distance by which the pushbutton 6 can be pushed downward. Each of the first limiting protrusions 6131 and a second limiting protrusion provided in the slide way 211 together define a maximum distance by which the pushbutton 6 can be slid upward, so as to prevent the pushbutton 6 from completely moving out of the slide way 211 from the open top of the main case 21.

The two coupling levers 41 are separately pressed against the two working portions 61.

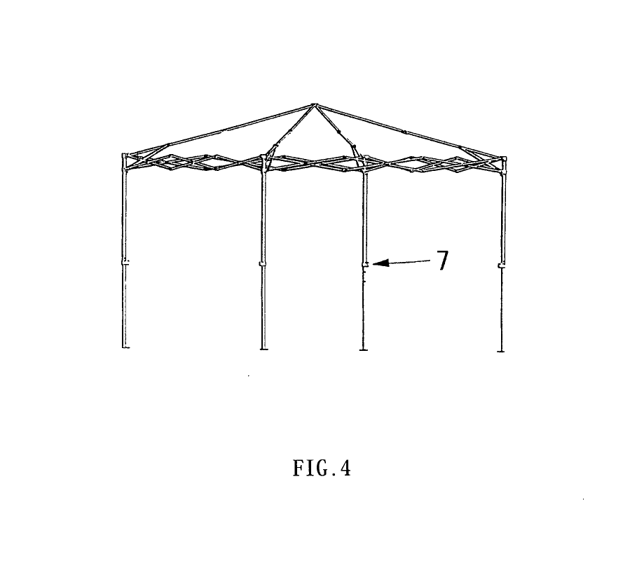

FIG. 4 shows a foldable tent frame including a plurality of telescopic poles. Each of the telescopic poles includes an outer pipe and an inner pipe telescopically received in the outer pipe, and a connection device 7 for adjustably connecting the outer pipe and the inner pipe to each other. The connection device 7 has a structure the same as the above-described telescopic pipe connection device of the present invention.

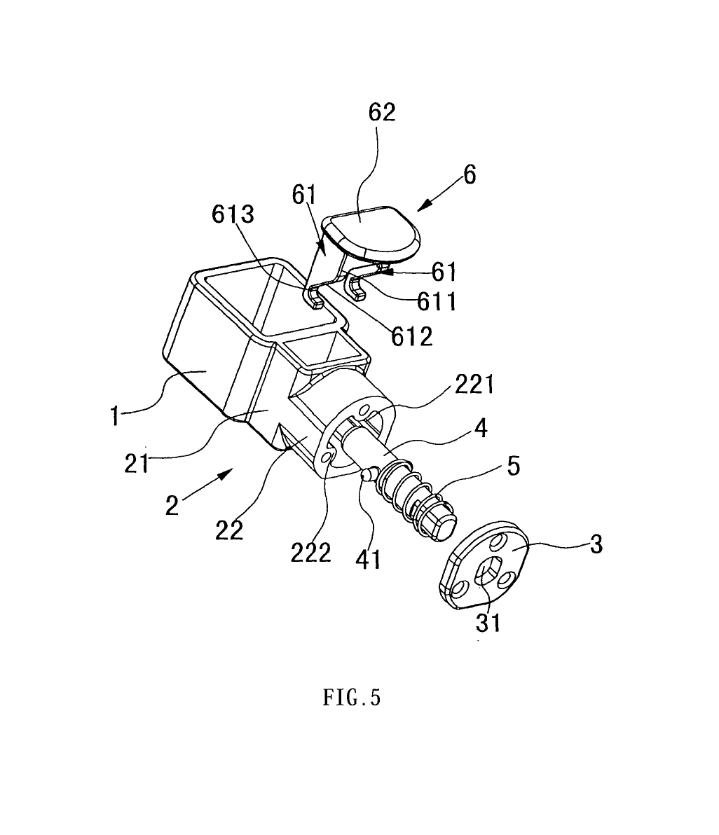

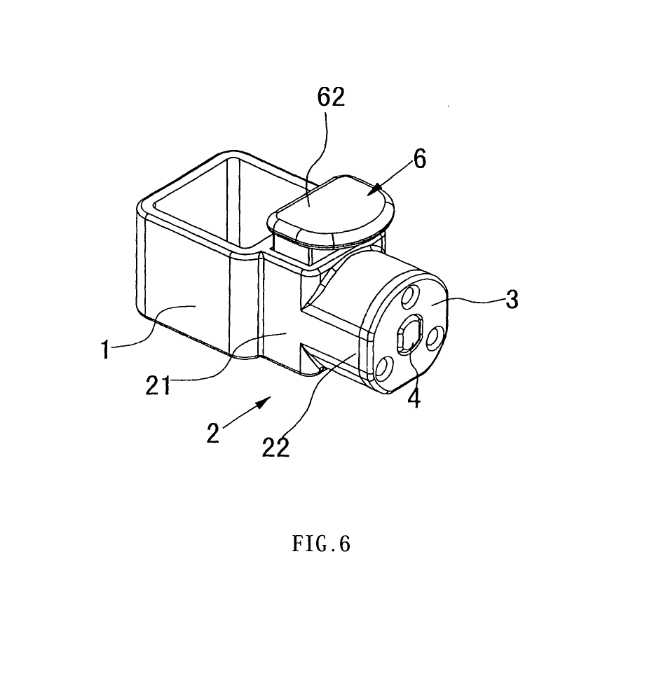

Please refer to FIGS. 5 and 6, in which a telescopic pipe connection device according to a second embodiment of the present invention is shown. The telescopic pipe connection device is mounted on an outer pipe and an inner pipe telescopically received in the outer pipe. The outer pipe is provided near an upper end with a working hole, which is a through hole. The inner pipe is provided on one side with a vertical line of spaced limiting holes. The telescopic pipe connection device includes a fixing sleeve 1, a setting-up case 2, a cap 3, a locating pin 4, a return spring 5, and a pushbutton 6.

The fixing sleeve 1 is fitted on around the upper end of the outer pipe and has four walls.

The setting-up case 2 includes a main case 21 and a secondary case 22. The main case 21 is fixedly connected to an outer side of a front wall of the fixing sleeve 1 (i.e. the first wall referred to in the summary of the invention), and the secondary case 22 is fixedly connected to an outer side of a front wall of the main case 21 and has an open front side (i.e. the fitting surface referred to in the summary of the invention). The main case 21 has an open top and internally defines a slide way 211. The secondary case 22 internally defines a horizontal through hole 221 which has an outer end located on the open front side of the secondary case 22 and extends through the setting-up case 2 and the front wall of the fixing sleeve 1 to communicate with the slide way 211 in the main case 21. Two radially inward protruded ribs 222 are symmetrically formed on an inner wall surface of the horizontal through hole 221.

The cap 3 is removably attached to the open front side of the secondary case 22 to close the outer end of the horizontal through hole 221. The cap 3 has a receiving hole 31 formed thereon.

The locating pin 4 is slidably extended through the horizontal through hole 221, and is provided on a peripheral wall with two coupling levers 41, which are symmetrically arranged relative to a centerline of the locating pin 4. The locating pin 4 has a first end extending through the outer pipe into one of the limiting holes on the inner pipe, and a second end engaged with the receiving hole 31. The second end of the locating pin 4 has a non-circular cross-sectional shape, and the receiving hole 31 has a cross-sectional shape matching that of the second end of the locating pin 4. The two coupling levers 41 are separately rest on the two protruded ribs 222.

The return spring 5 is fitted around the locating pin 4 with two ends separately pressed against the two coupling levers 41 and the cap 3.

The pushbutton 6 is slidably received in the slide way 211. The pushbutton 6 includes a button head 62 and two laterally spaced working portions 61 fixedly connected to a lower side of the button head 62. The locating pin 4 is located between the two working portions 61. Each of the two working portions 61 includes a straight portion 611, which is fixedly connected to one lateral end of the lower side of the button head 62 and has a straight front edge; a slant portion 612, which is fixedly connected to a lower edge of the straight portion 611 and has a slant front edge; and a hook portion 613 extended from the slant portion 612. The slant front edge of the slant portion 612 is rearward and downward inclined.

The two coupling levers 41 are separately pressed against the two working portions 61.

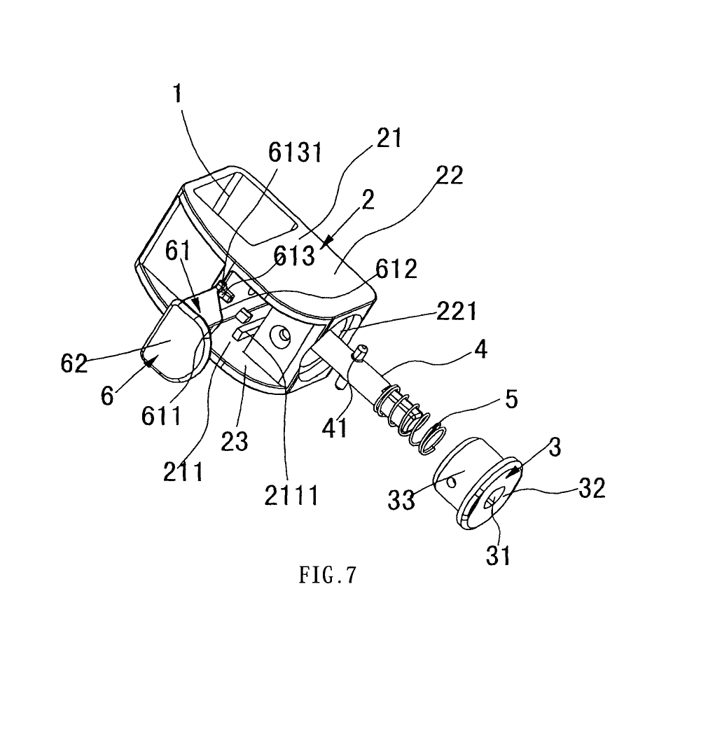

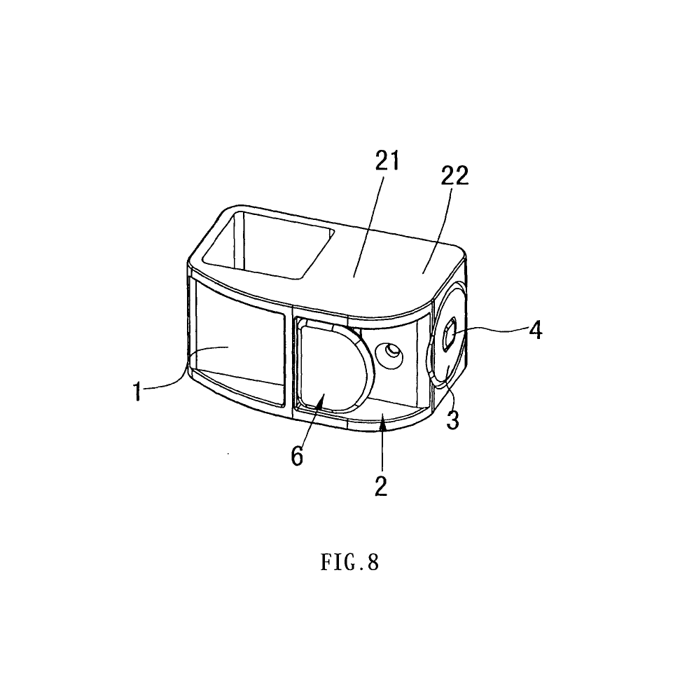

Please refer to FIGS. 7 and 8, in which a telescopic pipe connection device according to a third embodiment of the present invention is shown. The third embodiment is different from the first embodiment in that the main case 21 has an open left side instead of an open top, so that the pushbutton 6 slidably received in the slide way 211 is correspondingly changed in its relative positions on the connection device and in part of its structure. In the third embodiment, the pushbutton 6 includes a button head 62 and two vertically spaced working portions 61 fixedly connected to a right side of the button head 62. Each of the two working portions 61 includes a straight portion 611, which is fixedly connected to an upper or a lower end of the right side of the button head 62 and has a straight front edge; a slant portion 612, which is fixedly connected to a right edge of the straight portion 611 and has a slant front edge; and a hook portion 613 extended from the slant portion 612. The slant front edge of the slant portion 612 is rearward and rightward inclined.

A telescopic pipe connection device according to a fourth embodiment (not shown) is also provided. The fourth embodiment is different from the third embodiment in that the main case has an open right side instead of an open left side, so that the pushbutton slidably received in the slide way is correspondingly changed in its relative positions on the connection device and in part of its structure. In the fourth embodiment, the pushbutton includes a button head and two working portions fixedly connected to an upper and a lower end of a left side of the button head. Each of the two working portions includes a straight portion, which is fixedly connected to the upper or the lower end of the left side of the button head and has a straight front edge; a slant portion, which is fixedly connected to a left edge of the straight portion and has a slant front edge; and a hook portion extended from the slant portion. The slant front edge of the slant portion is rearward and leftward inclined.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A telescopic pipe connection device mounted on an outer pipe and an inner pipe telescopically received in the outer pipe and having a vertical line of spaced limiting holes provided on one side thereof, comprising:
a fixing sleeve being fitted on around an upper end of the outer pipe;
a setting-up case being fixedly connected to an outer side of a first wall of the fixing sleeve and internally defining a slide way communicating with an open top thereof; the setting-up case having a fitting surface opposite to and spaced from the first wall and further internally defining a horizontal through hole, the horizontal through hole having an outer end located on the fitting surface and extending through the setting-up case and the first wall of the fixing sleeve to communicate with the slide way;
a cap being removably attached to the fitting surface of the setting-up case and having a receiving hole formed thereon;
a locating pin being slidably extended through the horizontal through hole; the locating pin having a first end extended through the outer pipe to engage with one of the limiting holes and a second end engaged with the receiving hole; and the locating pin being provided on a peripheral surface with at least one coupling lever;
a return elastic element being fitted on around the locating pin with two ends pressed against the coupling lever and the cap; and
a pushbutton being slidably received in the slide way and having slant working faces formed on front edges of a lower portion thereof;
wherein the coupling lever is pressed against the slant working faces.

2. The telescopic pipe connection device as claimed in claim 1, wherein the second end of the locating pin has a non-circular cross-sectional shape and the receiving hole has a cross-sectional shape matching that of the second end of the locating pin.

3. The telescopic pipe connection device as claimed in claim 1, wherein the locating pin is provided on the peripheral surface with two coupling levers, which are symmetrically arranged relative to a centerline of the locating pin.

4. The telescopic pipe connection device as claimed in claim 3, wherein the horizontal through hole has two radially inward protruded ribs symmetrically formed on an inner wall surface thereof, and the two coupling levers being rest on the two protruded ribs.

5. The telescopic pipe connection device as claimed in claim 3, wherein the pushbutton includes a button head and two laterally spaced working portions fixedly connected to a lower side of the button head; the slant working faces being separately formed on front edges of lower portions of the two working portions; and the locating pin being located between the two working portions.

6. The telescopic pipe connection device as claimed in claim 5, wherein the front edge of each of the working portions includes a straight section, a slant section downward and rearward extended from the straight section, and a hook section extended from the slant section.

7. The telescopic pipe connection device as claimed in claim 1, wherein the pushbutton includes a button head, a straight portion fixedly connected to a lower side of the button head and having a straight front edge, a work portion fixedly connected to a lower edge of the straight portion and having a slant front edge, and a hook portion extended from the working portion.

8. A telescopic pipe connection device mounted on an outer pipe and an inner pipe telescopically received in the outer pipe and having a vertical line of spaced limiting holes provided on one side thereof, comprising:
a fixing sleeve being fitted on around an upper end of the outer pipe;
a setting-up case being fixedly connected to an outer side of a first wall of the fixing sleeve and internally defining a slide way communicating with an open right side thereof; the setting-up case having a fitting surface opposite to and spaced from the first wall and further internally defining a horizontal through hole, the horizontal through hole having an outer end located on the fitting surface and extending through the setting-up case and the first wall of the fixing sleeve to communicate with the slide way;
a cap being removably attached to the fitting surface of the setting-up case and having a receiving hole formed thereon;
a locating pin being slidably extended through the horizontal through hole; the locating pin having a first end extended through the outer pipe to engage with one of the limiting holes, and a second end engaged with the receiving hole; and the locating pin being provided on a peripheral surface with at least one coupling lever;
a return elastic element being fitted on around the locating pin with two ends pressed against the coupling lever and the cap; and
a pushbutton being slidably received in the slide way and having slant working faces formed on front edges of a left portion thereof;
wherein the coupling lever is pressed against the slant working faces.

9. A telescopic pipe connection device mounted on an outer pipe and an inner pipe telescopically received in the outer pipe and having a vertical line of spaced limiting holes provided on one side thereof, comprising:
a fixing sleeve being fitted on around an upper end of the outer pipe;
a setting-up case being fixedly connected to an outer side of a first wall of the fixing sleeve and internally defining a slide way communicating with an open left side thereof; the setting-up case having a fitting surface opposite to and spaced from the first wall and further internally defining a horizontal through hole, the horizontal through hole having an outer end located on the fitting surface and extending through the setting-up case and the first wall of the fixing sleeve to communicate with the slide way;
a cap being removably attached to the fitting surface of the setting-up case and having a receiving hole formed thereon;
a locating pin being slidably extended through the horizontal through hole; the locating pin having a first end extended through the outer pipe to engage with one of the limiting holes, and a second end engaged with the receiving hole; and the locating pin being provided on a peripheral surface with at least one coupling lever;
a return elastic element being fitted on around the locating pin with two ends pressed against the coupling lever and the cap; and
a pushbutton being slidably received in the slide way and having slant working faces formed on front edges of a right portion thereof;
wherein the coupling lever is pressed against the slant working faces.
